(19) United States
(12) Patent Application Publication
(10) Pub. No.: US 2025/0138800 A1
(43) Pub. Date: May 1, 2025

(54) SYSTEMS AND METHODS FOR SCANNING OPEN SOURCE DESKTOP BUS (D-BUS) CODE

(71) Applicant: Dell Products, L.P., Round Rock, TX (US)

(72) Inventors: Marshal F. Savage, Austin, TX (US); Charles D. Stracener, Carrollton, TX (US); John Paul Harvey, Round Rock, TX (US); Mini Thottunkal Thankappan, Bangalore (IN); Ion Florin Dragan, Cedar Park, TX (US)

(73) Assignee: Dell Products, L.P., Round Rock, TX (US)

(21) Appl. No.: 18/493,908

(22) Filed: Oct. 25, 2023

(51) Int. Cl. G06F 8/61; G06F 8/41

(52) U.S. Cl. CPC G06F 8/63; G06F 8/41

(57) ABSTRACT

Embodiments of the present disclosure provide a system and method to scan open source code files to alleviate illicit changes to those files. According to one embodiment, an Information Handling System (IHS) includes executable instructions to obtain an executable image having a build time symbol table that was generated when the executable image was built, compare a reference symbol table with the build time symbol table from the software image, and when the build time symbol table and the reference symbol table do not match, perform at least one remedial action. The executable image is configured to be installed on the BMC and includes at least one open source file that when built, comprises a D-Bus interface.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day IHS administrative management is often provided via baseboard management controllers (BMCs). The baseboard management controller (BMC) generally includes a specialized microcontroller embedded in the IHS, and may provide an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take certain corrective actions, such as resetting or power cycling the system to get a hung O/S running again. These abilities can often save on the total cost of ownership of an IHS, particularly when implemented in large clusters, such as server farms.

### SUMMARY

Embodiments of the present disclosure provide a system and method to scan open source code files to alleviate illicit changes to those files. According to one embodiment, an Information Handling System (IHS) includes executable instructions to obtain an executable image having a build time symbol table that was generated when the executable image was built, compare a reference symbol table with the build time symbol table from the software image, and when the build time symbol table and the reference symbol table do not match, perform at least one remedial action. The executable image is configured to be installed on the BMC and includes at least one open source file that when built, comprises a D-Bus interface.

According to another embodiment, an open source file scanning method includes the steps of obtaining an executable image comprising a build time symbol table that was generated when the executable image was built, the executable image configured to be installed on a Baseboard Management Controller (BMC) and comprising at least one open source file that when built comprises a D-Bus interface. The method further includes the steps of comparing a reference symbol table with the build time symbol table from the software image, and when the build time symbol table and the reference symbol table do not match, performing at least one remedial action.

According to yet another embodiment, a memory storage device is configured with program instructions stored thereon that, upon execution by one or more processors of a client Information Handling System (IHS), cause the client IHS to obtain an executable image comprising a build time symbol table that was generated when the executable image was built, the executable image configured to be installed on a Baseboard Management Controller (BMC) and comprising at least one open source file that when built comprises a D-Bus interface. The instructions further cause the HIS to compare a reference symbol table with the build time symbol table from the software image, and when the build time symbol table and the reference symbol table do not match, perform at least one remedial action.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A and 1B illustrate certain components of a chassis comprising one or more compute sleds and one or more storage sleds that may be configured to implement the systems and methods described according to one embodiment of the present disclosure.

FIG. 2 illustrates an example of an IHS configured to implement systems and methods described herein according to one embodiment of the present disclosure.

FIG. 3 illustrates several components of an open source code scanning system that may be used to detect changes in the source code used to build executable code when it is installed on a BMC according to one embodiment of the present disclosure.

FIG. 4 illustrates several components of another open source code scanning system that may be used to detect changes in the source code used to build an executable image during build time according to one embodiment of the present disclosure.

FIG. 5 illustrates an example reference symbol table updating method showing how the reference symbol table may be generated and updated according to one embodiment of the present disclosure.

FIG. 6 illustrates an example open source code scanning method showing how the executable image may be verified for authentic open source code files free of any illicit changes according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard specifications, such as the Intelligent Platform Management Interface (BMC) and Systems Management Architecture of Server Hardware (SMASH) for computer system administration. The BMC (also referred to as a remote access controller) may include a processor, memory, and an out-of-band network interface separate from and physically isolated from an in-band network interface of the IHS, and/or other embedded resources. In certain embodiments, the BMC may include or may be part of a BMC (e.g., a DELL Remote Access Controller (DRAC) or an Integrated DRAC (iDRAC)).

The BMC firmware is normally proprietary and is often developed by the vendor and shipped along with the BMC to the end user. Nevertheless, industry trends have migrated toward custom BMC firmware stacks (e.g., operating systems) that allow the end user greater control over how the BMC operates. OpenBMC is one example standard under which custom BMC firmware stacks may be generated. In general, openBMC is a collaborative open-source Linux distribution for BMCs meant to work across heterogeneous systems that include enterprise, high-performance computing (HPC), telecommunications, and cloud-scale data centers.

Advances in BMC design has led to the development of an Inter-Process Communication (IPC) and remote procedure call (RPC) mechanism, such as Desktop Bus (D-Bus), which typically operate outside the operating-system space. D-Bus is usually provided as a “daemon” process that functions in the background to effectively facilitate exchange of IPC messages between processes that provide various services. Implementation of D-Bus in BMCs are advantageous in that it provides for abstraction of invoking interfaces of a service and responding to interface invocations. Thus, the service may be shielded from, among other things, serialization and deserialization of data shared with other services, thus yielding portable services that may be easily migrated from one platform to another. Because D-Bus is a standard feature provided by the openBMC platform, it may be beneficial to re-use established services on other platforms, such as vendor-based platforms, such as Open Server Manager (OMS) provided by DELL TECHNOLOGIES and vice-versa.

Nevertheless, while implementation of D-Bus in BMCs may provide enhanced manageability, transparency, and customization, its implementation has not been without drawbacks. For example, many existing D-Bus interfaces and utilities are generated by sdbusplus, which is open-source code. In general, sdbusplus is a software library for interacting with D-Bus, and includes C++ bindings to ease the development of D-Bus applications. It is possible for the open-source code to be modified to be malicious. Moreover, this would not be easily detected by default due to the fact that the build environment is continually being updated with new versions of open source code. As will be described in detail herein below, embodiments of the present disclosure provide a solution to this problem via systems and methods to scan code for malicious code detection in which after the generated code is built into a library, a library symbol table can be obtained, which can be compared to a known good copy of the symbol table, and if any differences are found, a warning can be triggered.

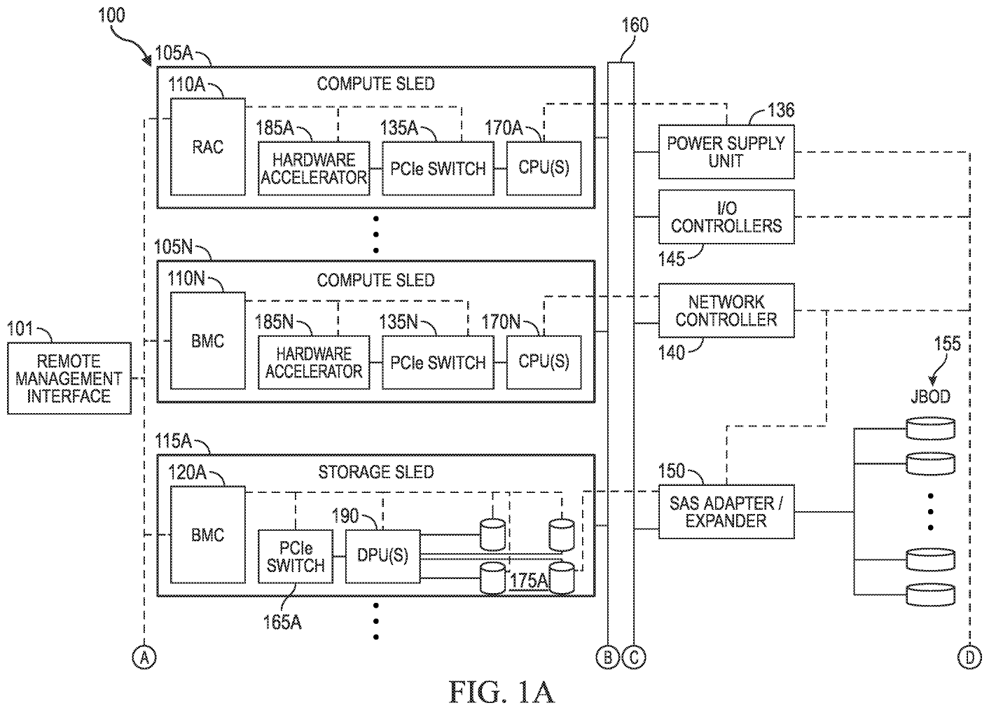

FIG. 1 is a block diagram illustrating certain components of a chassis 100 comprising one or more compute sleds 105a-n and one or more storage sleds 115a-n that may be configured to implement the systems and methods described according to one embodiment of the present disclosure. Embodiments of chassis 100 may include a wide variety of hardware configurations in which one or more sleds 105a-n, 115a-n are installed in chassis 100. Such variations in hardware configuration may result from chassis 100 being factory assembled to include components specified by a customer that has contracted for manufacture and delivery of chassis 100. Upon delivery and deployment of a chassis 100, the chassis 100 may be modified by replacing and/or adding various hardware components, in addition to replacement of the removable sleds 105a-n, 115a-n that are installed in the chassis. In addition, once the chassis 100 has been deployed, firmware used by individual hardware components of the sleds 105a-n, 115a-n, or by other hardware components of chassis 100, may be modified in order to update the operations that are supported by these hardware components.

Chassis 100 may include one or more bays that each receive an individual sled (that may be additionally or alternatively referred to as a tray, blade, and/or node), such as compute sleds 105a-n and storage sleds 115a-n. Chassis 100 may support a variety of different numbers (e.g., 4, 8, 16, 32), sizes (e.g., single-width, double-width) and physical configurations of bays. Embodiments may include additional types of sleds that provide various storage, power and/or processing capabilities. For instance, sleds installable in chassis 100 may be dedicated to providing power management or networking functions. Sleds may be individually installed and removed from the chassis 100, thus allowing the computing and storage capabilities of a chassis to be reconfigured by swapping the sleds with diverse types of sleds, in some cases at runtime without disrupting the ongoing operations of the other sleds installed in the chassis 100.

Multiple chassis 100 may be housed within a rack. Data centers may utilize large numbers of racks, with various different types of chassis installed in various configurations of racks. The modular architecture provided by the sleds, chassis and racks allow for certain resources, such as cooling, power, and network bandwidth, to be shared by the compute sleds 105a-n and storage sleds 115a-n, thus providing efficiency improvements and supporting greater computational loads. For instance, certain computational tasks, such as computations used in machine learning and other artificial intelligence systems, may utilize computational and/or storage resources that are shared within an IHS, within an individual chassis 100 and/or within a set of IHSs that may be spread across multiple chassis of a data center.

Implementing computing systems that span multiple processing components of chassis 100 is aided by high-speed data links between these processing components, such as PCIe connections that form one or more distinct PCIe switch fabrics that are implemented by PCIe switches 135a-n, 165a-n installed in the sleds 105a-n, 115a-n of the chassis. These high-speed data links may be used to support algorithm implementations that span multiple processing, networking, and storage components of an IHS and/or chassis 100. For instance, computational tasks may be delegated to a specific processing component of an IHS, such as to a hardware accelerator 185a-n that may include one or more programmable processors that operate separate from the main CPUs 170a-n of computing sleds 105a-n. In various embodiments, such hardware accelerators 185a-n may include DPUs (Data Processing Units), GPUs (Graphics Processing Units), SmartNICs (Smart Network Interface Card) and/or FPGAs (Field Programmable Gate Arrays). These hardware accelerators 185a-n operate according to firmware instructions that may be occasionally updated, such as to adapt the capabilities of the respective hardware accelerators 185a-n to specific computing tasks.

Chassis 100 may be installed within a rack structure that provides at least a portion of the cooling utilized by the sleds 105a-n, 115a-n installed in chassis 100. In supporting airflow cooling, a rack may include one or more banks of cooling fans that may be operated to ventilate heated air from within the chassis 100 that is housed within the rack. The chassis 100 may alternatively or additionally include one or more cooling fans 130 that may be similarly operated to ventilate heated air away from sleds 105a-n, 115a-n installed within the chassis. In this manner, a rack and a chassis 100 installed within the rack may utilize various configurations and combinations of cooling fans 130 to cool the sleds 105a-n, 115a-n and other components housed within chassis 100.

The sleds 105a-n, 115a-n may be individually coupled to chassis 100 via connectors that correspond to the bays provided by the chassis 100 and that physically and electrically couple an individual sled to a backplane 160. Chassis backplane 160 may be a printed circuit board that includes electrical traces and connectors that are configured to route signals between the various components of chassis 100 that are connected to the backplane 160 and between different components mounted on the printed circuit board of the backplane 160. In the illustrated embodiment, the connectors for use in coupling sleds 105a-n, 115a-n to backplane 160 include PCIe couplings that support high-speed data links with the sleds 105a-n, 115a-n. In various embodiments, backplane 160 may support diverse types of connections, such as cables, wires, midplanes, connectors, expansion slots, and multiplexers. In certain embodiments, backplane 160 may be a motherboard that includes various electronic components installed thereon. Such components installed on a motherboard backplane 160 may include components that implement all or part of the functions described with regard to the SAS (Serial Attached SCSI) expander 150, I/O controllers 145, network controller 140, chassis management controller 125 and power supply unit 136.

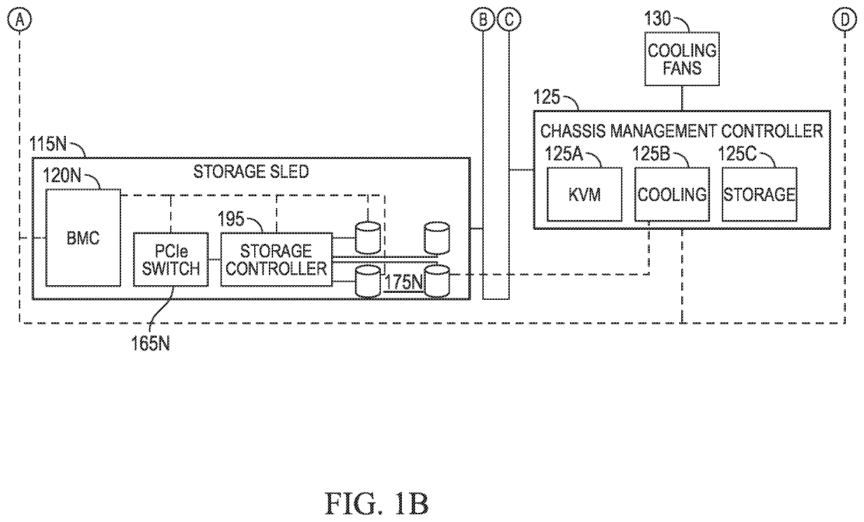

In certain embodiments, each individual sled 105a-n, 115a-n-n may be an IHS such as described with regard to IHS 200 of FIG. 2. Sleds 105a-n, 115a-n may individually or collectively provide computational processing resources that may be used to support a variety of e-commerce, multimedia, business, and scientific computing applications, such as artificial intelligence systems provided via cloud computing implementations. Sleds 105a-n, 115a-n are typically configured with hardware and software that provide leading-edge computational capabilities. Accordingly, services that are provided using such computing capabilities are typically provided as high-availability systems that operate with minimum downtime.

In high-availability computing systems, such as may be implemented using embodiments of chassis 100, any downtime that can be avoided is preferred. As described above, firmware updates are expected in the administration and operation of data centers, but it is preferable to avoid any downtime in making such firmware updates. For instance, in updating the firmware of the individual hardware components of the chassis 100, it is preferable that such updates can be made without having to reboot the chassis. As described in additional detail below, it is also preferable that updates to the firmware of individual hardware components of sleds 105a-n, 115a-n be likewise made without having to reboot the respective sled of the hardware component that is being updated.

As illustrated, each sled 105a-n, 115a-n includes a respective BMC 110a-n, 120a-n. As described in additional detail with regard to FIG. 2, BMC 110a-n, 120a-n provides capabilities for remote monitoring and management of a respective sled 105a-n, 115a-n and/or of chassis 100. In support of these monitoring and management functions, BMC s 110a-n may utilize both in-band and sideband (i.e., out-of-band) communications with various managed components of a respective sled 105a-n and chassis 100. BMC s 110a-n, 120a-n may collect diverse types of sensor data, such as collecting temperature sensor readings that are used in support of airflow cooling of the chassis 100 and the sleds 105a-n, 115a-n. In addition, each BMC 110a-n, 120a-n may implement various monitoring and administrative functions related to a respective sled 105a-n, 115a-n, where these functions may be implemented using sideband bus connections with various internal components of the chassis 100 and of the respective sleds 105a-n, 115a-n. As described in additional detail below, in various embodiments, these capabilities of the BMC s 110a-n, 120a-n may be utilized in updating the firmware of hardware components of chassis 100 and/or of hardware components of the sleds 105a-n, 115a-n, without having to reboot the chassis or any of the sleds 105a-n, 115a-n.

The BMC s 110a-n, 120a-n that are present in chassis 100 may support secure connections with a remote management interface 101. In some embodiments, remote management interface 101 provides a remote administrator with various capabilities for remotely administering the operation of an IHS, including initiating updates to the firmware used by hardware components installed in the chassis 100. For example, remote management interface 101 may provide capabilities by which an administrator can initiate updates to all of the storage drives 175a-n installed in a chassis 100, or to all of the storage drives 175a-n of a particular model or manufacturer. In some instances, remote management interface 101 may include an inventory of the hardware, software, and firmware of chassis 100 that is being remotely managed through the operation of the BMC s 110a-n, 120a-n. The remote management interface 101 may also include various monitoring interfaces for evaluating telemetry data collected by the BMC s 110a-n, 120a-n. In some embodiments, remote management interface 101 may communicate with BMC s 110a-n, 120a-n via a protocol such the Redfish remote management interface.

In the illustrated embodiment, chassis 100 includes one or more compute sleds 105a-n that are coupled to the backplane 160 and installed within one or more bays or slots of chassis 100. Each of the individual compute sleds 105a-n may be an IHS, such as described with regard to FIG. 2. Each of the individual compute sleds 105a-n may include various different numbers and types of processors that may be adapted to performing specific computing tasks. In the illustrated embodiment, each of the compute sleds 105a-n includes a PCIe switch 135a-n that provides access to a hardware accelerator 185a-n, such as the described DPUs, GPUs, Smart NICs and FPGAs, which may be programmed and adapted for specific computing tasks, such as to support machine learning or other artificial intelligence systems. As described in additional detail below, compute sleds 105a-n may include a variety of hardware components, such as hardware accelerator 185a-n and PCIe switches 135a-n, that operate using firmware that may be occasionally updated.

As illustrated, chassis 100 includes one or more storage sleds 115a-n that are coupled to the backplane 160 and installed within one or more bays of chassis 100 in a similar manner to compute sleds 105a-n. Each of the individual storage sleds 115a-n may include various different numbers and types of storage devices. As described in additional detail with regard to FIG. 2, a storage sled 115a-n may be an IHS 200 that includes multiple solid-state drives (SSDs) 175a-n, where the individual storage drives 175a-n may be accessed through a PCIe switch 165a-n of the respective storage sled 115a-n.

As illustrated, a storage sled 115a may include one or more DPUs (Data Processing Units) 190 that provide access to and manage the operations of the storage drives 175a of the storage sled 115a. Use of a DPU 190 in this manner provides low-latency and high-bandwidth access to numerous SSDs 175a. These SSDs 175a may be utilized in parallel through NVMe transmissions that are supported by the PCIe switch 165a that connects the SSDs 175a to the DPU 190. In some instances, PCIe switch 165a may be an integrated component of a DPU 190. The immense data storage and retrieval capabilities provided by such storage sled 115a implementations may be harnessed by offloading storage operations directed as storage drives 175a to a DPU 190a, and thus without relying on the main CPU of the storage sled, or of any other component of chassis 100. As indicated in FIG. 1, chassis 100 may also include one or more storage sleds 115n that provide access to storage drives 175n via a storage controller 195. In some embodiments, storage controller 195 may provide support for RAID (Redundant Array of Independent Disks) configurations of logical and physical storage drives, such as storage drives provided by storage sled 115n. In some embodiments, storage controller 195 may be a HBA (Host Bus Adapter) that provides more limited capabilities in accessing storage drives 175n.

In addition to the data storage capabilities provided by storage sleds 115a-n, chassis 100 may provide access to other storage resources that may be installed components of chassis 100 and/or may be installed elsewhere within a rack that houses the chassis 100. In certain scenarios, such storage drives 155 may be accessed via a SAS expander 150 that is coupled to the backplane 160 of the chassis 100. The SAS expander 150 may support connections to a number of JBOD (Just a Bunch of Disks) storage drives 155 that, in some instances, may be configured and managed individually and without implementing data redundancy across the various drives 155. The additional storage drives 155 may also be at various other locations within a datacenter in which chassis 100 is installed.

In light of the various manners in which storage drives 175a-n, 155 may be coupled to chassis 100, a wide variety of different storage topologies may be supported. Through these supported topologies, storage drives 175a-n, 155 may be logically organized into clusters or other groupings that may be collectively tasked and managed. In some instances, a chassis 100 may include numerous storage drives 175a-n, 155 that are identical, or nearly identical, such as arrays of SSDs of the same manufacturer and model. Accordingly, any firmware updates to storage drives 175a-n, 155 require the updates to be applied within each of these topologies being supported by the chassis 100. Despite the substantial number of different storage drive topologies that may be supported by an individual chassis 100, the firmware used by each of these storage devices 175a-n, 155 may be occasionally updated. In some instances, firmware updates may be limited to a single storage drive, but in other instances, firmware updates may be initiated for a large number of storage drives, such as for all SSDs installed in chassis 100.

As illustrated, the chassis 100 of FIG. 1 includes a network controller 140 that provides network access to the sleds 105a-n, 115a-n installed within the chassis. Network controller 140 may include various switches, adapters, controllers, and couplings used to connect chassis 100 to a network, either directly or via additional networking components and connections provided via a rack in which chassis 100 is installed. Network controller 140 operates according to firmware instructions that may be occasionally updated.

Chassis 100 may similarly include a power supply unit 135 that provides the components of the chassis with various levels of DC power from an AC power source or from power delivered via a power system provided by a rack within which chassis 100 may be installed. In certain embodiments, power supply unit 135 may be implemented within a sled that may provide chassis 100 with redundant, hot-swappable power supply units. Power supply unit 135 may operate according to firmware instructions that may be occasionally updated.

Chassis 100 may also include various I/O controllers 145 that may support various I/O ports, such as USB ports that may be used to support keyboard and mouse inputs and/or video display capabilities. Each of the I/O controllers 145 may operate according to firmware instructions that may be occasionally updated. Such I/O controllers 145 may be utilized by the chassis management controller 125 to support various KVM (Keyboard, Video and Mouse) 125a capabilities that provide administrators with the ability to interface with the chassis 100. The chassis management controller 125 may also include a storage module 125c that provides capabilities for managing and configuring certain aspects of the storage devices of chassis 100, such as the storage devices provided within storage sleds 115a-n and within the JBOD 155.

In addition to providing support for KVM 125a capabilities for administering chassis 100, chassis management controller 125 may support various additional functions for sharing the infrastructure resources of chassis 100. In some scenarios, chassis management controller 125 may implement tools for managing the power supply unit 135, network controller 140 and airflow cooling fans 130 that are available via the chassis 100. As described, the airflow cooling fans 130 utilized by chassis 100 may include an airflow cooling system that is provided by a rack in which the chassis 100 may be installed and managed by a cooling module 125b of the chassis management controller 125.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 illustrates an example of an IHS 200 configured to implement systems and methods described herein according to one embodiment of the present disclosure. It should be appreciated that although the embodiments described herein may describe an IHS that is a compute sled or similar computing component that may be deployed within the bays of a chassis, a variety of other types of IHSs, such as laptops and portable devices, may also operate according to embodiments described herein. In the illustrative embodiment of FIG. 2, IHS 200 may be a computing component, such as sled 105a-n, 115a-n, or other type of server, such as an 1RU server installed within a 2RU chassis, which is configured to share infrastructure resources provided within a chassis 100.

IHS 200 may utilize one or more system processors 205, that may be referred to as CPUs (central processing units). In some embodiments, CPUs 205 may each include a plurality of processing cores that may be separately delegated with computing tasks. Each of the CPUs 205 may be individually designated as a main processor and as a co-processor, where such designations may be based on delegation of specific types of computational tasks to a CPU 205. In some embodiments, CPUs 205 may each include an integrated memory controller that may be implemented directly within the circuitry of each CPU 205. In some embodiments, a memory controller may be a separate integrated circuit that is located on the same die as the CPU 205. Each memory controller may be configured to manage the transfer of data to and from a system memory 210 of the IHS, in some cases using a high-speed memory bus. The system memory 210 is coupled to CPUs 205 via one or more memory buses 205a that provide the CPUs 205 with high-speed memory used in the execution of computer program instructions by the CPUs 205. Accordingly, system memory 210 may include memory components, such as static RAM (SRAM), dynamic RAM (DRAM), NAND Flash memory, suitable for supporting high-speed memory operations by the CPUs 205. In certain embodiments, system memory 210 may combine persistent non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to diverse types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each CPU 205. All or portions of the chipset may be implemented directly within the integrated circuitry of an individual CPU 205. The chipset may provide the CPU 205 with access to a variety of resources accessible via one or more in-band buses. IHS 200 may also include one or more I/O ports 215 that may be used to couple the IHS 200 directly to other IHSs, storage resources, diagnostic tools, and/or other peripheral components. A variety of additional components may be coupled to CPUs 205 via a variety of in-line buses. For instance, CPUs 205 may also be coupled to a power management unit 220 that may interface with a power system of the chassis 100 in which IHS 200 may be installed. In addition, CPUs 205 may collect information from one or more sensors 225 via a management bus.

In certain embodiments, IHS 200 may operate using a BIOS (Basic Input/Output System) that may be stored in a non-volatile memory accessible by the CPUs 205. The BIOS may provide an abstraction layer by which the operating system of the IHS 200 interfaces with hardware components of the HIS 200. Upon powering or restarting IHS 200, CPUs 205 may utilize BIOS instructions to initialize and test hardware components coupled to the HIS 200, including both components permanently installed as components of the motherboard of IHS 200 and removable components installed within various expansion slots supported by the IHS 200. The BIOS instructions may also load an operating system for execution by CPUs 205. In certain embodiments, IHS 200 may utilize Unified Extensible Firmware Interface (UEFI) in addition to or instead of a BIOS. In certain embodiments, the functions provided by a BIOS may be implemented, in full or in part, by the BMC 230.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of HIS 200, such as the BIOS and boot loader of IHS 200. These calculated hash values may then be compared against reference hash values that were previously stored in a secure non-volatile memory of the HIS 200, such as during factory provisioning of IHS 200. In this manner, a TPM may establish a root of trust that includes core components of IHS 200 that are validated as operating using instructions that originate from a trusted source.

As illustrated, CPUs 205 may be coupled to a network controller 240, such as provided by a Network Interface Controller (NIC) card that provides IHS 200 with communications via one or more external networks, such as the Internet, a LAN, or a WAN. In some embodiments, network controller 240 may be a replaceable expansion card or adapter that is coupled to a connector (e.g., PCIe connector of a motherboard, backplane, midplane, etc.) of IHS 200. In some embodiments, network controller 240 may support high-bandwidth network operations by the IHS 200 through a PCIe interface that is supported by the chipset of CPUs 205. Network controller 240 may operate according to firmware instructions that may be occasionally updated.

As indicated in FIG. 2, in some embodiments, CPUs 205 may be coupled to a PCIe card 255 that includes two PCIe switches 265a-b that operate as I/O controllers for PCIe communications, such as TLPs (Transaction Layer Packets), that are transmitted between the CPUs 205 and PCIe devices and systems coupled to IHS 200. Whereas the illustrated embodiment of FIG. 2 includes two CPUs 205 and two PCIe switches 265a-b, different embodiments may operate using different numbers of CPUs and PCIe switches. In addition to serving as I/O controllers that route PCIe traffic, PCIe switches 265a-b include switching logic that can be used to expand the number of PCIe connections that are supported by CPUs 205. PCIe switches 265a-b may multiply the number of PCIe lanes available to CPUs 205, thus allowing more PCIe devices to be connected to CPUs 205, and for the available PCIe bandwidth to be allocated with greater granularity. Each of the PCIe switches 265a-b may operate according to firmware instructions that may be occasionally updated.

Using the available PCIe lanes, the PCIe switches 265a-b may be used to implement a PCIe switch fabric. Also through this switch fabric, PCIe NVMe (Non-Volatile Memory Express) transmission may be supported and utilized in high-speed communications with SSDs, such as storage drives 235a-b, of the IHS 200. Also through this switch fabric, PCIe VDM (Vendor Defined Messaging) may be supported and utilized in managing PCIe-compliant hardware components of the IHS 200, such as in updating the firmware utilized by the hardware components.

As indicated in FIG. 2, IHS 200 may support storage drives 235a-b in various topologies, in the same manner as described with regard to the chassis 100 of FIG. 1. In the illustrated embodiment, storage drives 235a are accessed via a hardware accelerator 250, while storage drives 235b are accessed directly via PCIe switch 265b. In some embodiments, the storage drives 235a-b of IHS 200 may include a combination of both SSD and magnetic disk storage drives. In other embodiments, all of the storage drives 235a-b of IHS 200 may be identical, or nearly identical. In all embodiments, storage drives 235a-b operate according to firmware instructions that may be occasionally updated.

As illustrated, PCIe switch 265a is coupled via a PCIe link to a hardware accelerator 250, such as a DPU, SmartNIC, GPU and/or FPGA, that may be a connected to the HIS 200 via a removable card or baseboard that couples to a PCIe connector of the IHS 200. In some embodiments, hardware accelerator 250 includes a programmable processor that can be configured for offloading functions from CPUs 205. In some embodiments, hardware accelerator 250 may include a plurality of programmable processing cores and/or hardware accelerators, which may be used to implement functions used to support devices coupled to the IHS 200. In some embodiments, the processing cores of hardware accelerator 250 include ARM (advanced RISC (reduced instruction set computing) machine) processing cores. In other embodiments, the cores of the DPUs may include MIPS (microprocessor without interlocked pipeline stages) cores, RISC-V cores, or CISC (complex instruction set computing) (i.e., x86) cores. Hardware accelerator may operate according to firmware instructions that may be occasionally updated.

In the illustrated embodiment, the programmable capabilities of hardware accelerator 250 implement functions used to support storage drives 235a, such as SSDs. In such storage drive topologies, hardware accelerator 250 may implement processing of PCIe NVMe communications with storage drives 235a, thus supporting high-bandwidth connections with the storage drives. Hardware accelerator 250 may also include one or more memory devices used to store program instructions executed by the processing cores and/or used to support the operation of storage drives 235a such as in implementing cache memories and buffers utilized in support of high-speed operation of these storage drives, and in some cases may be used to provide high-availability and high-throughput implementations of the read, write and other I/O operations that are supported by these storage drives 235a. In other embodiments, hardware accelerator 250 may implement operations in support of other types of devices and may similarly support high-bandwidth PCIe connections with these devices. For instance, in various embodiments, hardware accelerator 250 may support high-bandwidth connections, such as PCIe connections, with networking devices in implementing functions of a network switch, compression and codec functions, virtualization operations or cryptographic functions.

As illustrated in FIG. 2, PCIe switches 265a-b may also support PCIe couplings with one or more GPUs (Graphics Processing Units) 260. Embodiments may include one or more GPU cards, where each GPU card is coupled to one or more of the PCIe switches 265a-b, and where each GPU card may include one or more GPUs 260. In some embodiments, PCIe switches 265a-b may transfer instructions and data for generating video images by the GPUs 260 to and from CPUs 205. Accordingly, GPUs 260 may include one or more hardware-accelerated processing cores that are optimized for performing streaming calculation of vector data, matrix data and/or other graphics data, thus supporting the rendering of graphics for display on devices coupled either directly or indirectly to IHS 200. In some instances, GPUs may be utilized as programmable computing resources for offloading other functions from CPUs 205, in the same manner as hardware accelerator 250. GPUs 260 may operate according to firmware instructions that may be occasionally updated.

As illustrated in FIG. 2, PCIe switches 265a-b may support PCIe connections in addition to those utilized by GPUs 260 and hardware accelerator 250, where these connections may include PCIe links of one or more lanes. For instance, PCIe connectors 245 supported by a printed circuit board of IHS 200 may allow various other systems and devices to be coupled to HIS 200. Through couplings to PCIe connectors 245, a variety of data storage devices, graphics processors and network interface cards may be coupled to IHS 200, thus supporting a wide variety of topologies of devices that may be coupled to the IHS 200.

As described, IHS 200 includes a BMC 230 that supports remote management of IHS 200 and of various internal components of IHS 200. In certain embodiments, BMC 230 may operate from a different power plane from the processors 205 and other components of IHS 200, thus allowing the BMC 230 to operate, and management tasks to proceed, while the processing cores of IHS 200 are powered off. Various functions provided by the BIOS, including launching the operating system of the IHS 200, and/or functions of a TPM may be implemented or supplemented by the BMC 230. In some embodiments, the BMC 230 may perform various functions to verify the integrity of the IHS 200 and its hardware components prior to initialization of the operating system of IHS 200 (i.e., in a bare-metal state). In some embodiments, certain operations of the BMC 230, such as the operations described herein for updating firmware used by managed hardware components of IHS 200, may operate using validated instructions, and thus within the root of trust of IHS 200.

In some embodiments, BMC 230 may include a service processor 230a, or specialized microcontroller, which operates management software that supports remote monitoring and administration of IHS 200. The management operations supported by BMC 230 may be remotely initiated, updated, and monitored via a remote management interface 101, such as described with regard to FIG. 1. BMC 230 may be installed on the motherboard of IHS 200 or may be coupled to IHS 200 via an expansion slot or other connector provided by the motherboard. In some instances, the management functions of the BMC 230 may utilize information collected by various managed sensors 225 located within the IHS. For instance, temperature data collected by sensors 225 may be utilized by the BMC 230 in support of closed-loop airflow cooling of the IHS 200. As indicated, BMC 230 may include a secured memory 230e for exclusive use by the BMC in support of management operations.

In some embodiments, BMC 230 may implement monitoring and management operations using MCTP (Management Component Transport Protocol) messages that may be communicated to managed devices 205, 235a-b, 240, 250, 255, 260 via management connections supported by a sideband bus 253. In some embodiments, the BMC 230 may additionally or alternatively use MCTP messaging to transmit Vendor Defined Messages (VDMs) via the in-line PCIe switch fabric supported by PCIe switches 265a-b. In some instances, the sideband management connections supported by BMC 230 may include PLDM (Platform Level Data Model) management communications with the managed devices 205, 235a-b, 240, 250, 255, 260 of IHS 200.

As illustrated, BMC 230 may include a network adapter 230c that provides the BMC with network access that is separate from the network controller 240 utilized by other hardware components of the IHS 200. Through secure connections supported by network adapter 230c, BMC 230 communicates management information with remote management interface 101. In support of remote monitoring functions, network adapter 230c may support connections between BMC 230 and external management tools using wired and/or wireless network connections that operate using a variety of network technologies. As a non-limiting example of a BMC, the integrated Dell Remote Access Controller (iDRAC) from Dell® is embedded within Dell servers and provides functionality that helps information technology (IT) administrators deploy, update, monitor, and maintain servers remotely.

BMC 230 supports monitoring and administration of the managed devices of an IHS via a sideband bus interface 253. For instance, messages utilized in device and/or system management may be transmitted using I2C sideband bus 253 connections that may be individually established with each of the respective managed devices 205, 235a-b, 240, 250, 255, 260 of the IHS 200 through the operation of an I2C multiplexer 230d of the BMC. As illustrated in FIG. 2, the managed devices 205, 235a-b, 240, 250, 255, 260 of IHS 200 are coupled to the CPUs 205, either directly or directly, via in-line buses that are separate from the I2C sideband bus 253 connections used by the BMC 230 for device management.

In certain embodiments, the service processor 230a of BMC 230 may rely on an I2C co-processor 230b to implement sideband I2C communications between the BMC 230 and the managed hardware components 205, 235a-b, 240, 250, 255, 260 of the IHS 200. The I2C co-processor 230b may be a specialized co-processor or micro-controller that is configured to implement an I2C bus interface used to support communications with managed hardware components 205, 235a-b, 240, 250, 255, 260 of HIS 200. In some embodiments, the I2C co-processor 230b may be an integrated circuit on the same die as the service processor 230a, such as a peripheral system-on-chip feature that may be provided by the service processor 230a. The sideband I2C bus 253 is illustrated as single line in FIG. 2. However, sideband bus 253 may be comprised of multiple signaling pathways, where each may be comprised of a clock line and data line that couple the BMC 230 to I2C endpoints 205, 235a-b, 240, 250, 255, 260.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

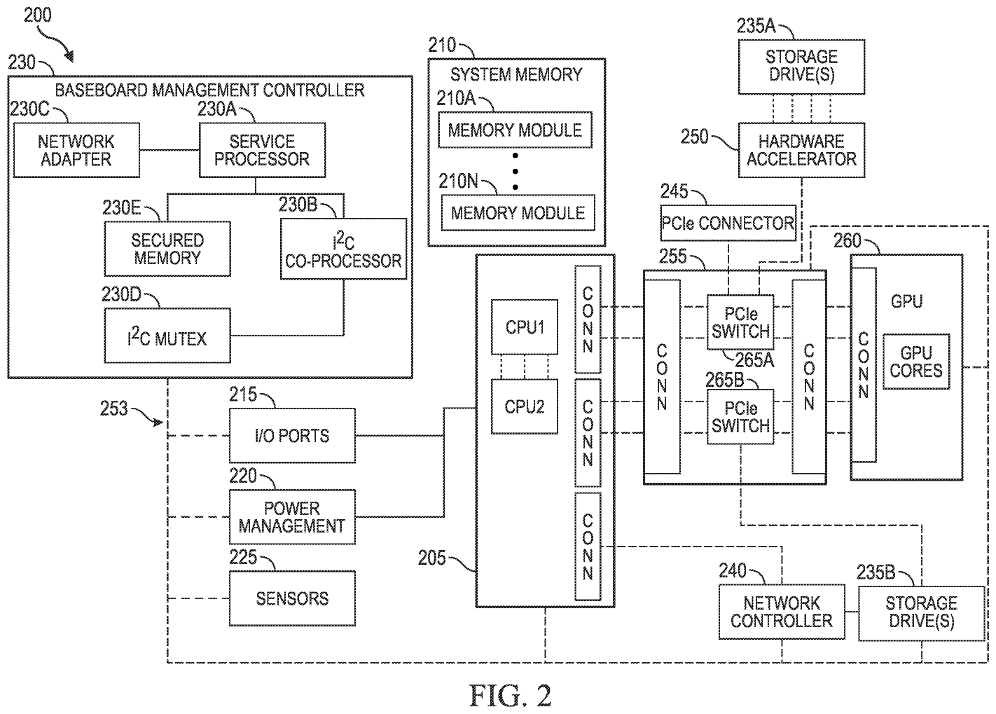

FIG. 3 illustrates several components of an open source code scanning system 300 that may be used to detect changes in the source code used to build executable code when it is installed on a BMC according to one embodiment of the present disclosure. The open source scanning system 300 includes a BMC 230 that may be used to manage the operation of an IHS 200 using a BMC Graphical User Interface (GUI) 302. The BMC 230 includes a D-Bus process 304 that provides inter process communications among multiple services 306a-u (collectively 306). According to embodiments of the present disclosure, the RAC 230 is configured with a D-Bus service authenticity verifier 308 and a symbol table 310, which will be described in detail herein below, may be embodied as instructions stored in a memory and executed by a processor configured in the RAC 230.

The services 306 using the D-Bus 304 may be any suitable type. As shown, services 306 that use the D-Bus 304 may include a Secure Enterprise Key Manager (SEKM) module 306a, a telemetry module 306b, a support assist module 306c, a non-root GUI module 306d, a non-root redfish module 306e, an IPMI module 306f, a SEL/Event logger module 306g, an entity manager 306h, a thermal/PID control module 306i, a GPIO monitor 306j, a LED manager 306k, a power control and state manager 306l, a temp sensor daemon 306n, a Field Replaceable Unit (FRU) device daemon 306o, an IPMB bridge daemon 306p, a Power Supply Unit (PSU) sensor daemon 306q, an NVMe sensor daemon 306r, a fan sensor daemon 306s, an LED controller module 306t, and a GPIO/Buttons module 306u. It should be appreciated that other embodiments may have additional, fewer, or different services 306 than what is shown and described herein.

For the purposes of this disclosure, the term “BMC GUI” may refer broadly to systems that are configured to couple to a management controller, such as a BMC 230, and issue management instructions for an information handling system (e.g., computing device) that is being managed by the management controller. One example of such a system management console is the DELL OpenManage Enterprise (OME) systems management console. In various embodiments, management consoles may be implemented via specialized hardware and/or via software running on a standard information handling system. In one embodiment, a system management console may be deployed on a secure virtual machine (VM), such as a VMWARE Workstation appliance.

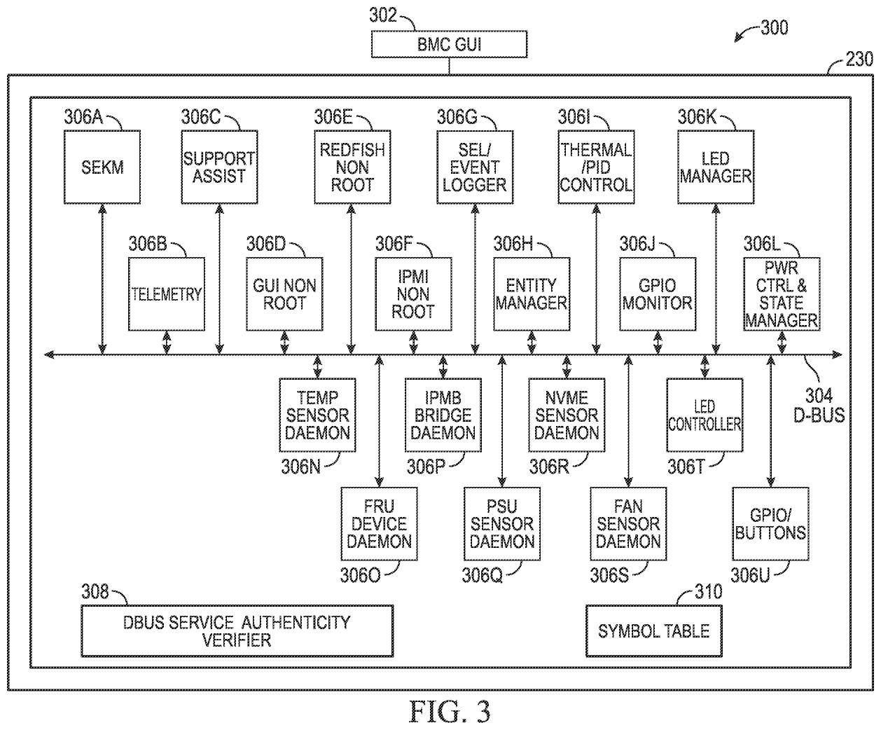

FIG. 4 illustrates several components of another open source code scanning system 400 that may be used to detect changes in the source code used to build an executable image during build time according to one embodiment of the present disclosure. While the open source scanning system 300 may be suitable for checking for changes in source code after the executable image has been installed on a BMC 230, the open source code scanning system 400 may be used to check for changes in the source code at any suitable time, such as during a build time of its respective executable image. The open source scanning system 400 also includes a build time D-Bus interface authenticity verifier 406 that verifies whether the information included in the symbol table 414 matches the information included in the reference symbol table 416.

In one embodiment, the open source code scanning system 400 may be used to scan executable code of a BMC. Nevertheless, it is contemplated that the open source code scanning system 400 may be used to scan executable code of any updateable device that executes code that is updated from time to time. The open source code scanning system 400 may be particularly beneficial when used with BMCs 230, which are implemented with D-Bus because, among other things, D-Bus is supported with numerous D-Bus interfaces that are open source. That is, developers would like to have the ability to re-use established open source code rather than develop the code from scratch. Code that is open source, however, may be difficult to ensure its integrity because it is openly available for review and/or changing by others. This problem may be compounded by the fact that updates to the open source code are made available at ongoing intervals, thus requiring that each updated version be verified for its integrity. Thus, as will be described in detail herein below, the open source code scanning system 400 provides a technique for ensuring the integrity of open source code, such as that implemented with D-Bus-based BMCs that use open source code, such as D-Bus libraries.

The open source code scanning system 400 generally includes a build environment 402 comprising a source code symbol table updater 404 that controls a compiler/linker 408 to receive one or more open source code files 410 to generate an executable image 412, such as a D-Bus library file, and a library symbol table 414. The symbol table 414 generally refers to a data structure, which stores information about occurrences of various entities in a software program in which each entity includes an identifier and a corresponding address or offset. Some examples of an entity of a software program may include, for example, a function identifier, a label identifier, a variable identifier, a function argument identifier and an instruction identifier. Thus, the executable image 412, which may be installed on the BMC 230, may be included with a symbol table 414 that includes information about the source code used to build the executable image 412. The source code symbol table updater 404 may also be used to continually monitor authenticated distribution channels for updated source code files or new source code files from which a reference symbol table 416 may be generated and stored in a database 418 of the build environment 402.

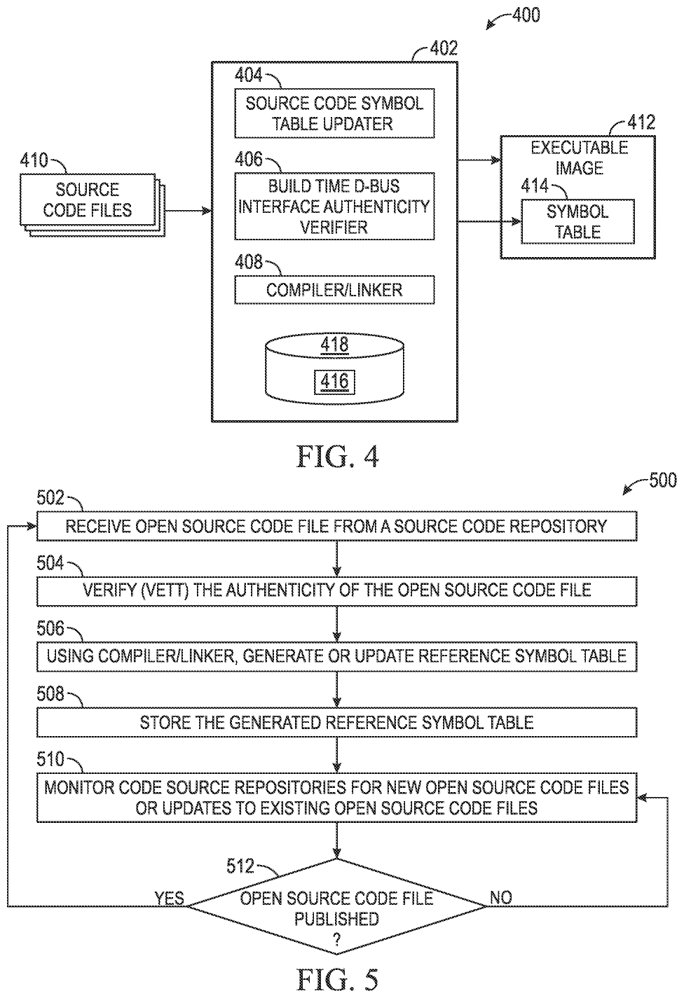

In one aspect, the symbol table 414 may be considered to be a signature or a unique identifier associated with how the source code files 410 were written. For example, if one of the source code 410 files are changed, the symbol table 414 would also change to reflect the new, changed, or deleted instructions in the source code files 410. Once the executable image 412 is built, the symbol table 414 will always reflect its composition because the executable image 412 is essentially immutable, that is, it cannot reasonably be changed or modified. Thus, throughout the serviceable life of the executable image 412, the symbol table 414 may be compared against one or more reference symbol tables generated from known good open source code files as will be described in detail below with reference to FIG. 5.

FIG. 5 illustrates an example reference symbol table updating method 500 showing how the reference symbol table 414 may be generated and updated according to one embodiment of the present disclosure. Additionally or alternatively, the reference symbol table updating method 500 may be performed in whole or in part, by the open source code scanning system 400 as shown and described above with reference to FIG. 4.

Initially at step 502, the reference symbol table updating method 500 receives an open source code file 410 from a source code repository. For example, the reference symbol table updating method 500 may download the source code files 410 from an online distribution site, such as GITHUB.COM. The reference symbol table updating method 500 may then verify the authenticity of the open source code file 410 at step 504. In one embodiment, the reference symbol table updating method 500 may ensure that the source code files 410 was downloaded using a secure communication link, or that the distribution site has provided the latest official copy of the source code files 410. In one embodiment, the reference symbol table updating method 500 may verify the authenticity of the source code files 410 using a GNU Privacy Guard (GPG) signature.

Thereafter at step 506, the reference symbol table updating method 500 may, using the compiler/linker 408, generate or update the reference symbol table 416. For example, if the reference symbol table 416 has already been generated, the reference symbol table updating method 500 may update the existing reference symbol table 416 with the symbols from the newly obtained source code files 410. The reference symbol table updating method 500 then stores the generated/updated reference symbol table 416 in a memory, such as a memory of the build environment where the executed image 412 is built at step 508. At step 510, the reference symbol table updating method 500 monitors source code repositories for new open source code files or updates to existing open source code files. It may do this on a continual basis due to the fact that numerous source code files exist that are each associated with D-Bus interfaces that may be implemented on the BMC 230, and each of those source code files are continually publishing software updates.

At step 512, the reference symbol table updating method 500 determines whether any new open source code files 410 have been published. If not, processing continues at step 510 for continual monitoring for the availability of new or updated open source code files 410. If, however, a new open source code file 410 has been made available, the reference symbol table updating method 500 may then continue processing at step 502 to receive and process the new or updated open source code file 410.

In one embodiment, the reference symbol table updating method 500 is performed continually to receive and process newly available open source code files 410. Nevertheless, when use of the reference symbol table updating method 500 is no longer needed or desired, the process ends.

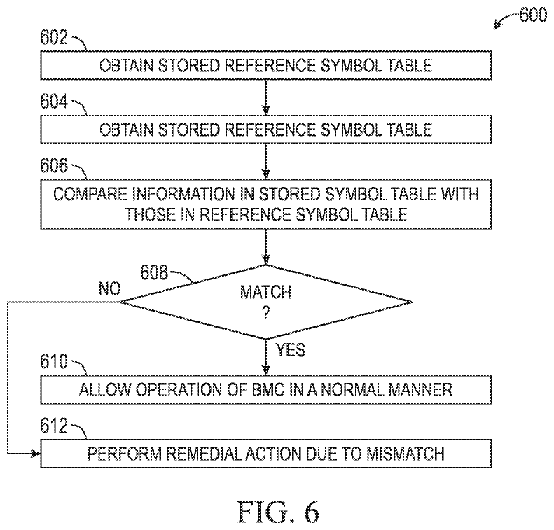

FIG. 6 illustrates an example open source code scanning method 600 showing how the executable image 412 may be verified for authentic open source code files 410 free of any illicit changes according to one embodiment of the present disclosure. Additionally or alternatively, the open source code scanning method 600 may be performed in whole or in part, by the open source code scanning system 400 during build time of the executable image 412, or by the open source scanning system 300 after the executable image 412 has been installed on the BMC 230. The open source code scanning method 600 may be performed at any suitable time, such as whenever the integrity of the executable image 412 is desired to be verified.

At step 602, the open source code scanning method 600 obtains the stored symbol table. If the executable image 412 is verified after it has been installed on the BMC 230, the open source code scanning method 600 may obtain the symbol table 310 stored in a memory of the BMC 230. If, however, the executable image 412 is being verified at another time, such as during build time of the executable image 412, the open source code scanning method 600 may obtain the symbol table 414 stored in the executable image 412. In one embodiment, the symbol table 310 is stored within the executable image 412 such that, when it is installed on the BMC 230, the symbol table 310 is accessible from the executable image 412. In another embodiment, the symbol table 310 is stored in compressed form on the executable image 412 in order to save the limited storage capabilities of the BMC 230. In yet another embodiment, the symbol table 310 is encrypted and/or hidden so that illicit users cannot access it to tamper with its contents.

In yet another embodiment, the symbol table 310 includes metadata information about all D-Bus interfaces installed on the executable image 412. The symbol table 310 may include metadata associated with versioning information for each open source code file 410 used to build the executable image 412. For example, one particular version of executable image 412 may use a certain version of source code files 410, while another version of executable image 412 may use a different version of source code files 410. Thus, by maintaining information about which version of each source code files 410 is used, the proper symbol information for that version of executable image 412 may be checked for authenticity.

At step 604, the open source code scanning method 600 obtains the reference symbol table 416, such as the one generated in FIG. 4. For example, the reference symbol table 416 may be obtained from internal memory 418 if the authentication is performed at build time, or alternatively, it may be obtained from an external repository, such as an online support site, if the authentication is performed after the executable image 412 has been installed on the BMC 230.

At step 606, the open source code scanning method 600 compare information in the stored symbol table 310 or 414 with those in reference symbol table 416. If the tables match at step 608, processing continues at step 610 in which the BMC 230 is allowed to resume operation in a normal manner. If, however, the tables do not match, indicating that at least one of the open source code files 410 have been changed, processing continues at step 612 in which a remedial action is performed. Examples of remedial actions may include inhibiting the BMC 230 or its associated IHS 200 from normal operation or generating and sending an alert message, such as one that may be sent to the RAC GUI 302 to inform the user that at least one open source code file 410 has been changed.

The aforedescribed process may be performed each time that it is needed or desired for the executable image 412 to be checked for authentic open source files 410. Nevertheless, when use of the open source code scanning method 600 is no longer needed or desired, the open source code scanning method 600 ends.

Although FIGS. 5 and 6 describes example methods 500 and 600 that may be performed to verify the authenticity of open source code files implemented in a BMC 230, the features of the disclosed processes may be embodied in other specific forms without deviating from the spirit and scope of the present disclosure. For example, certain steps of the disclosed methods 500 and 600 may be performed sequentially, or alternatively, they may be performed concurrently. As another example, the methods 500 and 600 may perform additional, fewer, or different operations than those operations as described in the present example. As yet another example, the steps of the processes described herein may be performed by a manual or executable process other than the BMC 230 or open source code scanning system 400 as described above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a Baseboard Management Controller (BMC);
at least one processor; and
at least one memory coupled to the at least one processor, the at least one memory having program instructions stored thereon that, upon execution by the at least one processor, cause the IHS to:
obtain an executable image comprising a build time symbol table that was generated when the executable image was built, the executable image configured to be installed on the BMC and comprising at least one open source file that when built comprises a D-Bus interface;
compare a reference symbol table with the build time symbol table from the software image; and
when the build time symbol table and the reference symbol table do not match, perform at least one remedial action.

2. The IHS of claim 1, wherein the instructions, upon execution, cause the IHS to:
obtain the symbol table from a compiler when the executable image is built; and
store the build time symbol table in the executable image.

3. The IHS of claim 2, wherein the instructions, upon execution, cause the IHS to compress the build time symbol table.

4. The IHS of claim 1, wherein the instructions, upon execution, cause the IHS to when the acts of obtaining an executable image, comparing the reference symbol table with the build time symbol table and performing at least one remedial action are performed by the BMC, obtain the executable image from an external source.

5. The IHS of claim 1, wherein the instructions, upon execution, cause the IHS to when the acts of obtaining an executable image, comparing the reference symbol table with the build time symbol table and performing at least one remedial action are performed external to the BMC, obtain the executable image from a local source.

6. The IHS of claim 1, wherein the remedial action comprises at least one of inhibiting operation of the BMC or sending an alert message.

7. The IHS of claim 1, wherein the instructions, upon execution, cause the IHS to:
monitor a source code repository for a new or updated open source file;
generate a new symbol table from the open source file; and
store the new symbol table in the reference symbol table.

8. The IHS of claim 7, wherein the instructions, upon execution, cause the IHS to verify the authenticity of the open source file prior to storing the new symbol table in the reference symbol table.

9. An open source file scanning method comprising:
obtaining an executable image comprising a build time symbol table that was generated when the executable image was built, the executable image configured to be installed on a Baseboard Management Controller (BMC) and comprising at least one open source file that when built comprises a D-Bus interface;
comparing a reference symbol table with the build time symbol table from the software image; and
when the build time symbol table and the reference symbol table do not match, performing at least one remedial action.

10. The open source scanning method of claim 9, further comprising:
obtaining the symbol table from a compiler when the executable image is built; and
storing the build time symbol table in the executable image.

11. The open source scanning method of claim 10, further comprising compressing the build time symbol table.

12. The open source scanning method of claim 9, further comprising, when the acts of obtaining an executable image, comparing the reference symbol table with the build time symbol table and performing at least one remedial action are performed by the BMC, obtaining the executable image from an external source.

13. The open source scanning method of claim 9, further comprising, when the acts of obtaining an executable image, comparing the reference symbol table with the build time symbol table and performing at least one remedial action are performed external to the BMC, obtaining the executable image from a local source.

14. The open source scanning method of claim 9, further comprising:
monitoring a source code repository for a new or updated open source file;
generating a new symbol table from the open source file; and
storing the new symbol table in the reference symbol table.

15. The open source scanning method of claim 14, further comprising verifying the authenticity of the open source file prior to storing the new symbol table in the reference symbol table.

16. A memory storage device having program instructions stored thereon that, upon execution by one or more processors of a client Information Handling System (IHS), cause the client IHS to:
obtain an executable image comprising a build time symbol table that was generated when the executable image was built, the executable image configured to be installed on a Baseboard Management Controller (BMC) and comprising at least one open source file that when built comprises a D-Bus interface;
compare a reference symbol table with the build time symbol table from the software image; and
when the build time symbol table and the reference symbol table do not match, perform at least one remedial action.

17. The memory storage device of claim 16, wherein the instructions, upon execution, cause the IHS to:
obtain the symbol table from a compiler when the executable image is built; and
store the build time symbol table in the executable image.

18. The memory storage device of claim 17, wherein the instructions, upon execution, cause the IHS to compress the build time symbol table.

19. The memory storage device of claim 16, wherein the instructions, upon execution, cause the IHS to:
monitor a source code repository for a new or updated open source file;
generate a new symbol table from the open source file; and
store the new symbol table in the reference symbol table.

20. The memory storage device of claim 19, wherein the instructions, upon execution, cause the IHS to verify the authenticity of the open source file prior to storing the new symbol table in the reference symbol table.
